(19) United States
(12) Patent Application Publication
(10) Pub. No.: US 2002/0059099 A1
(43) Pub. Date: May 16, 2002

(54) Method and apparatus for collecting on-line consumer data and streaming advertisements in response to sweepstakes participation

(76) Inventor: Craig J. Coletta, Hoboken, NJ (US)

Correspondence Address: Ronald E. Brown, Pitney, Hardin, Kipp & Szuch LLP, 711 Third Avenue, New York, NY, 10017, US

(21) Appl. No.: 09/892,102

(22) Filed: Jun. 26, 2001

Related U.S. Application Data
(60) Provisional application No. 60/214,108, filed on Jun. 26, 2000.

(51) Int. Cl. G06F 17/60; G06F 15/167; G09G 5/00

(52) U.S. Cl. 705/14; 345/781; 709/213

(57) ABSTRACT

The method for communication between a central computer, such as a server, and various remote computers communicate information regarding the on-line behavior of the remote users to the central computer during an internet session, which typically includes various URL's. The central computer analyzes this on-line behavior and directs advertisements to each user based on the remote user's on-line behavior. These advertisements are typically streamed onto a taskbar shaped area on the screen of the remote user. Additionally, information regarding the awarding of future prizes is streamed to the user and displayed on the taskbar shaped area. Information regarding the awarding of the prize is likewise streamed to the user and displayed on the toolbar shaped area. Typically, a user must be logged on during the communication of the information regarding the awarding of the prize in order to be eligible for receiving the prize.

This application claims priority from provisional application Serial No. 60/214,108, filed on Jun. 26, 2000, the disclosure of which is incorporated herein by reference.

### BACKGROUND OF THE INVENTION

1. Field of the Invention

The invention pertains to a method and apparatus for a browser companion to persistently maintain a taskbar display on a user's computer screen during a web session, collecting information regarding the user's on-line choices and behavior, periodically awarding prizes to those user who has used the browser companion during a specific period of time, and streaming directed advertisements to the user based upon the on-line behavior and choices.

2. Description of the Prior Art

The Internet marketplace has been developing at a record pace for several years. As it continues to grow, it is evolving from a market place driven by competition for user traffic into one driven by the acquisition of customer profiles. U.S. Pat. No. 5,848,396 entitled “Method and Apparatus for Determining Behavioral Profile of a Computer User” issued on Dec. 8, 1998 to Gerace and U.S. Pat. No. 5,991,735 entitled “Computer Program Apparatus for Determining Behavioral Profile of a Computer User” issued on Nov. 23, 1999 to Gerace relate to obtaining information regarding the on-line habits of a computer user. However, these references do not adequately disclose how to make a user enthusiastic about the collection of this information.

The on-line sweepstakes portal “iwon” provides all of the users who log in during a given day to win a sweepstakes prize. However, this has the drawback that it may lose effectiveness after the original excitement has subsided. Members who wish to enter the daily sweepstakes must visit the site each day, earn entries, and then come back the next day to see if they have won. This activity can become a chore. Another drawback is that a member may just log in momentarily for entry in the daily sweepstakes and then quickly log off. The company may capture basic demographic data but will not have a sufficient associated advertising opportunity. This may lead to a decline in advertising, which is the fundamental revenue stream at such web-sites. In order for the sweepstakes model to be truly effective, a site must not only offer new and different prizes, but must keep the offers excites by adding variations and make entry as simple as possible.

Another model is the “pay-for-surfing” sites which use multi-level marketing techniques. However, a small monetary stipend is typically not sufficient incentive for an internet user to divulge the desired personal information. Moreover, the multi-level marketing techniques, requiring a user to sign up other users, have the deficiencies inherent in any pyramid scheme.

### OBJECTS AND SUMMARY OF THE INVENTION

It is therefore an object of the present invention to provide an improved method and apparatus for collecting data regarding a user's on-line behavior and choices.

It is therefore a further object of the present invention to provide an improved method and apparatus for directing on-line advertisements to a user based upon that user's on-line behavior and choices.

It therefore a further object of the present invention to provide an on-line sweepstakes which maintains the excitement of the web user, particularly by allowing the user to compete while “surfing” the internet.

These and other objects are attained by providing the computer user with a program or browser companion that collects information regarding the user's on-line behavior and choices while generating a taskbar that remains persistently on a portion of the user's desktop during a web session (typically involving multiple URLs). This taskbar streams advertisements to the user based upon the collected information. In order to attract the user and the maintain the user's interest, prizes are periodically awarded to a randomly selected user or users who has used the browser companion during a specific period of time. Additionally, information collected from the user can be used to select non-cash awards for the user. While it is envisioned that non-cash prizes would be awarded, in the event that a user is not eligible for some awards (such as a monetary award) due to age, a scholarship may be awarded instead.

### BRIEF DESCRIPTION OF THE DRAWINGS

Further objects and advantages of the invention will become apparent from the following description, and from the accompanying drawings, wherein:

FIG. 1 is a schematic of a taskbar on a computer screen in accordance with the present invention.

FIG. 2 is a schematic of the environment of the present invention.

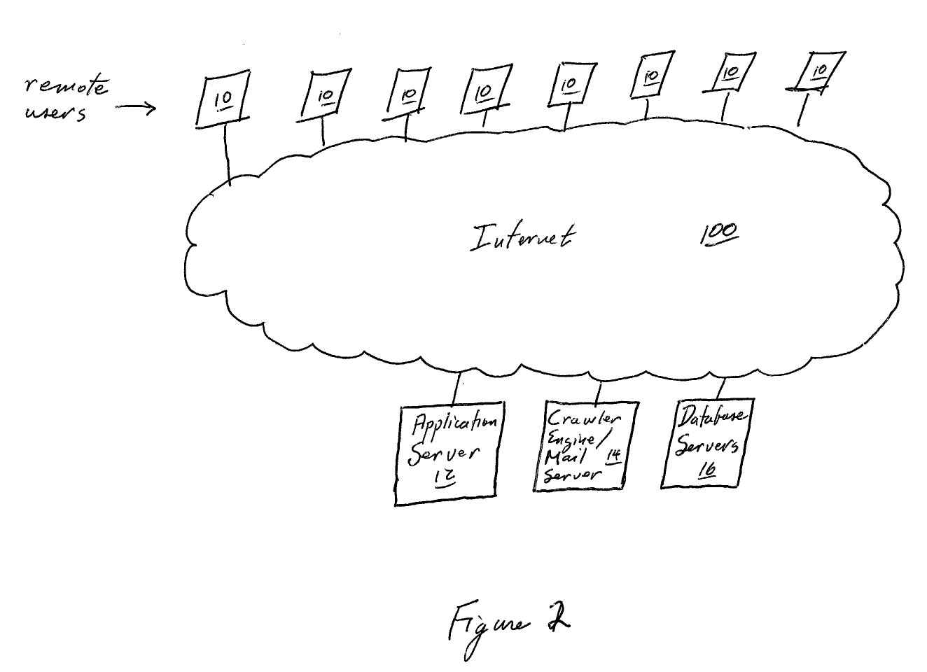

FIG. 3 is a schematic of the taskbar of the present invention.

### DETAILED DESCRIPTION OF THE PREFERRED EMBODIMENT

At the outset, this application claims priority from provisional application Serial No. 60,214,108, filed on Jun. 26, 2000, the disclosure of which is herein incorporated by reference.

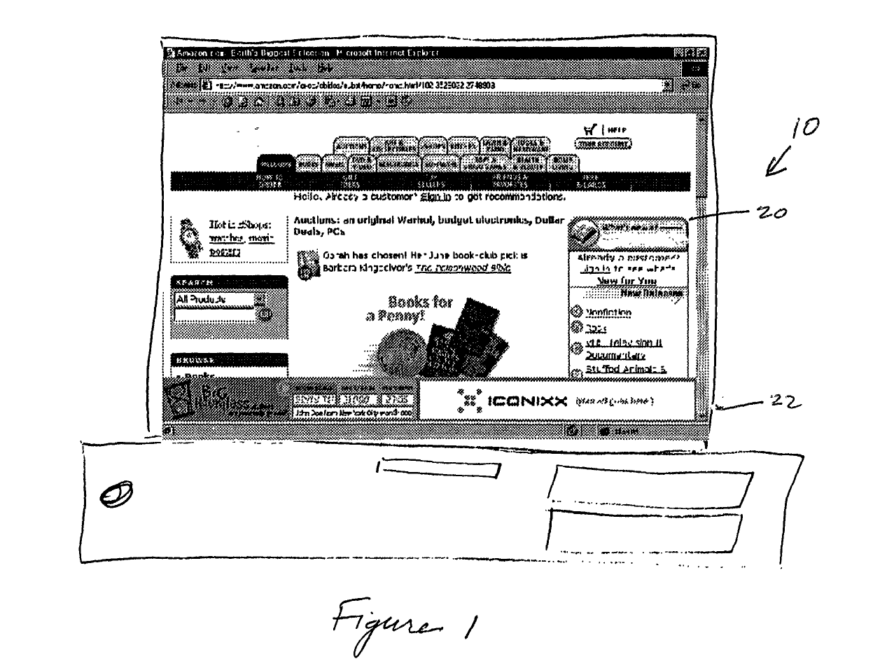

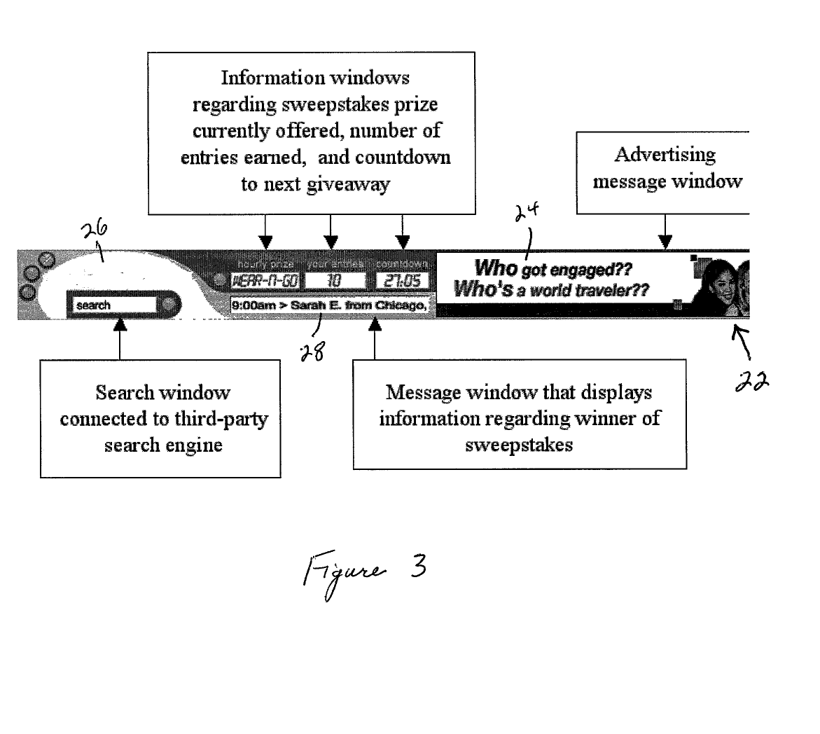

In order to participate in the method of the invention, a remote user at one of remote computers 10 must become a registered user. In order to do this, the user typically communicates via the internet 100 to application server 12, crawler engine/mail server 14 and/or database servers 16 in order to complete a user profile and further to retrieve the required software or browser companion. After the software or browser companion is retrieved, it resides in remote computer 10 and communicates on-line user behavior, such as which URL's are accessed during internet sessions, to application server 12 (which is in communication with crawler engine/mail server 14 and database server 16) via internet 100. This information, in conjunction with the information provided in the user profile during registration, is used to evaluate which advertisements may be of interest of the remote user. These advertisements are then communicated via internet 100 and are displayed on lower taskbar 22 of screen 20 (see FIG. 1). More particularly, as shown on FIG. 3, lower taskbar 22 includes an advertising message window 24.

Moreover, this method is frequently performed on behalf of a particular consumer business, so the lower taskbar 22 can be branded with the trademarks of this particular consumer business. Moreover, the website which is accessed by the user during the initial registration process can be branded with the trademarks of the particular consumer business.

Additionally, the lower taskbar 22 includes access via search window 26 to a third party search engine.

Application server 12 further communicates information to the remote users 10 regarding a sweepstakes and the future awarding of prizes. This information is communicated to remote users 10 and displayed on sweepstakes information windows 28. This information might typically include the sweepstakes prize being offered, the number of entries earned, the countdown to the next giveaway and a message window that displays information regarding recent winners of the sweepstakes. The application server 12 would further communicate information to a remote user 10 indicating that a remote user had won. Typically, the remote user 10 would have to be logged-on and participating in a web session with the browser companion activated in order to be eligible to win a prize.

In summary, application servers 12 provide functionality including, but not limited to, calculation of winners in the online sweepstakes, communications and process requirements associated with the taskbar, and integration with third-party advertising server. Crawler Engine/Mail Server 14 provides emailing list services to the website and also act as a Web crawler engine—i.e. it retrieves and catalogs meta-tag information from Web sites visited by the users. It also analyzes this meta-tag information to make certain assumptions regarding users' likely interests in various interest categories. Database servers 16 process and store membership, sponsor, prize, and related site information, typically in the Oracle 8i database.

Additionally, the back end processes will perform the giveaways, send e-mails, and calculate behavioral interest profiles based on URLs browsed by users of remote computers 10.

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

What is claimed is:

1. A method of communicating between a central computer and a number of remote computers operated by a number of users during internet sessions, including the steps of:
collecting information regarding users' on-line behavior throughout internet sessions and communicating said information to said central computer;
communicating advertisements from said central computer to said remote computers, said advertisements being selected in response to said information regarding on-line behavior for each user;
displaying said advertisements on a first portion of a selected area of a screen of said remote computers; and
communicating information regarding future prizes and periodically communicating information regarding the award of a prize from said central computer to said remote computers and displaying at least a portion of said information regarding future prizes and the award of a prize on a second portion of said selected area of a screen of said remote computers, wherein users can be awarded prizes if a user's internet session occurs during communication of information regarding the award of a prize.
